(19) United States
(12) Patent Application Publication
(10) Pub. No.: US 2005/0129201 A1
(43) Pub. Date: Jun. 16, 2005

(54) Method and system for offering free telecommunication services

(76) Inventors: Patrick Palmer, Houston, TX (US); David Parkes, Toronto (CA); Anthony Lacavera, Toronto (CA); Gerry Marshall, Toronto (CA)

Correspondence Address: Ralph A. Dowell;Dowell & Dowell, P.C., Suite 406, 2111 Eisenhower Avenue, Alexandria, VA, 22314, US

(21) Appl. No.: 10/965,953

(22) Filed: Oct. 18, 2004

Related U.S. Application Data
(60) Provisional application No. 60/511,329, filed on Oct. 16, 2003.

(51) Int. Cl. H04M 15/00

(52) U.S. Cl. 379/114.01; 379/428.01

(57) ABSTRACT

A method and system of offering reduced cost telecommunication services to a consumer while simultaneously providing multimedia promotional content to the consumer. A method and system of distributing multimedia content to at least one terminal offering telephony or internet connection services. Video and audio output devices, such as a display screen and terminal speakers, are provided for presenting multimedia promotional content to the consumer. Data input devices are also provided so the consumer may interact with the system to request further information. Promotional contents are centrally managed at one or several centralized locations and distributed to the terminals periodically or as needed. Promotional contents distributed to each terminal may be customized based on the location of the terminal or the usage statistics of the terminal, among several other factors.

This application claims priority from U.S. provisional application having Ser. No. 60/511,329 that was filed on Oct. 16, 2003.

### BACKGROUND OF THE INVENTION

1. Field of the Invention

The present invention relates to a telecommunication system and method.

2. Description of the Prior Art

Advertising is constantly evolving, and through the advent of new technologies, many new and innovative approaches to advertising are now possible. Advertisers tend to place promotional materials on billboards or multi-screen displays at specific sites rather than random site locations in order to target broad audiences. However, in order to target an individual consumer or a smaller group of consumers, advertisements are often placed in bus shelters, public washrooms or telephone booths.

Advertisers have also found that they can entice consumers to notice or experience their advertisements by offering free products or services. For example, offering free telephony services is well known, where such free services are available in exchange for listening to a short audio promotional message in place of a dial tone, or listening to promotional messages interspaced during the consumer's call. However, this is generally a nuisance to the consumer, as such interruptions are unforeseen and generally break the flow of conversation. Another way involves placing stationary advertisements in a phone booth offering free telephone calls. However, due to the static nature of the print advertisements, such advertisements are typically non-engaging and can be easily ignored by a consumer.

It is an object of the present invention to mitigate or obviate at least one of the above mentioned disadvantages.

### SUMMARY OF THE INVENTION

In one of its aspects, the present invention provides a method and system for offering telecommunication services to at least one consumer while simultaneously providing multimedia promotional content to at least one consumer.

In another of its aspects, the invention provides a method and system for distributing multimedia content to at least one multimedia terminal offering telecommunication services.

In one aspect of the invention, there is provided a system for providing telecommunication services to a user, while presenting simultaneously promotional content to the user. The system has a terminal connected to a communication network, a content server for providing the promotional content, and a central server for providing the telecommunication services to the user and for directing the content server to provide the promotional content to the terminal. The terminal has an access unit for permitting the user to receive the telecommunication services and an output device for presenting the promotional content. The access unit may be a telephone set, a network connector or a radio antenna for the user to connect a mobile telecommunication equipment to the terminal wirelessly.

In a feature of this aspect of the invention, the terminal includes a circuit element to reduce the output of audio component of the promotional content when the telephone set is in use.

In another feature of this aspect of the invention, the terminal further includes a data input device for the user to interact with the system The data input device may be the telephone's key pad, a bar code scanner, a computer keyboard, a joystick, a computer mouse or a touch screen built into a graphic screen of the output device.

In yet another feature of this aspect of the invention, the terminal has a computer readable medium for storing a copy of the promotional content that may be updated at pre-determined time intervals.

In another feature of this aspect of the invention, the terminal includes a coupon generator for producing a customized coupon. The coupon may expire at a pre-determined time to encourage purchase of the merchandise by the user from the store.

In one aspect of the invention, there is provided a terminal for use in a telecommunication system for providing telecommunication services to a user, while presenting simultaneously promotional content to the user. The terminal has an access unit so the user may receive the telecommunication services, an output device for presenting the promotional content, and a processor. The processor is programmable to control network communication between the access unit and a communication network, to receive the promotional content and to present the promotional content on the output device. The access unit may be a telephone set, a network connector or a radio antenna for the user to connect a mobile telecommunication equipment to the terminal wirelessly.

In another aspect of the invention, there is provided a method of providing telecommunication services to a user. The method includes the steps of providing a terminal from which the user receives the telecommunication services, receiving a request from the user for receiving the telecommunication services, providing the requested telecommunication services, and presenting the promotional content to the user. The terminal has an output device for presenting promotional content.

In a feature of this aspect of the invention, the method includes the step of presenting a portion of the promotional content in a loop when the terminal is not used by a user.

In another feature of this aspect of the invention, the terminal includes a telephone set for providing telephony services and the method includes the step of reducing output of audio component of the promotional content while the telephone set is in use.

In yet another aspect of the invention, there is provided a system for providing telecommunication services to a user, while presenting simultaneously promotional content to the user. The system includes a terminal connected to a communication network. The terminal has an access unit for permitting the user to receive the telecommunication services, a display screen, a terminal speaker, a computer readable medium and a processor. The processor is programmable to control network connection between the access unit and the communication network. The display screen, the terminal speaker and the computer readable medium are accessible to the processor. The system also includes a content server for providing the promotional content stored on its content database and a central server for providing the telecommunication services to the user and for directing the content server to provide the promotional content to the terminal.

Advantageously, the multimedia terminals offering telecommunication services are positioned in locations that experience increased volume of consumers such as stadiums, hospitals, airports, train stations, bus stations, malls, regional or national stores such as LOBLAWS®, SHOPPERS DRUGMART®, BESTBUY®, ‘big box’ stores such as WALMART® or THE HOME DEPOT®. By placing such terminals in or adjacent to retail stores, those retail stores are presented with increased traffic and increased sales.

Another advantage of the invention is that consumers are able to receive telecommunication services, and advertisers can increase their targeted audience at reduced costs.

### BRIEF DESCRIPTION OF THE DRAWINGS

These and other features of the preferred embodiments of the invention will become more apparent in the following detailed description in which reference is made to the appended drawings wherein:

FIG. 1 is a system for distributing multimedia content;

FIG. 2 is a front view of a terminal used in FIG. 1;

FIG. 3 is a sectional view of the terminal along line 2-2′;

FIG. 4 is a flowchart including the steps for providing telecommunication services and promotional content to a consumer;

FIG. 5 is a view of a screen displaying an advertised product;

FIG. 6 is a flowchart including the steps for providing telecommunication services while interacting with the system of FIG. 1; and

FIG. 7 shows schematically a terminal according to an alternative embodiment for use in the system shown in FIG. 1.

### DESCRIPTION OF THE PREFERRED EMBODIMENTS

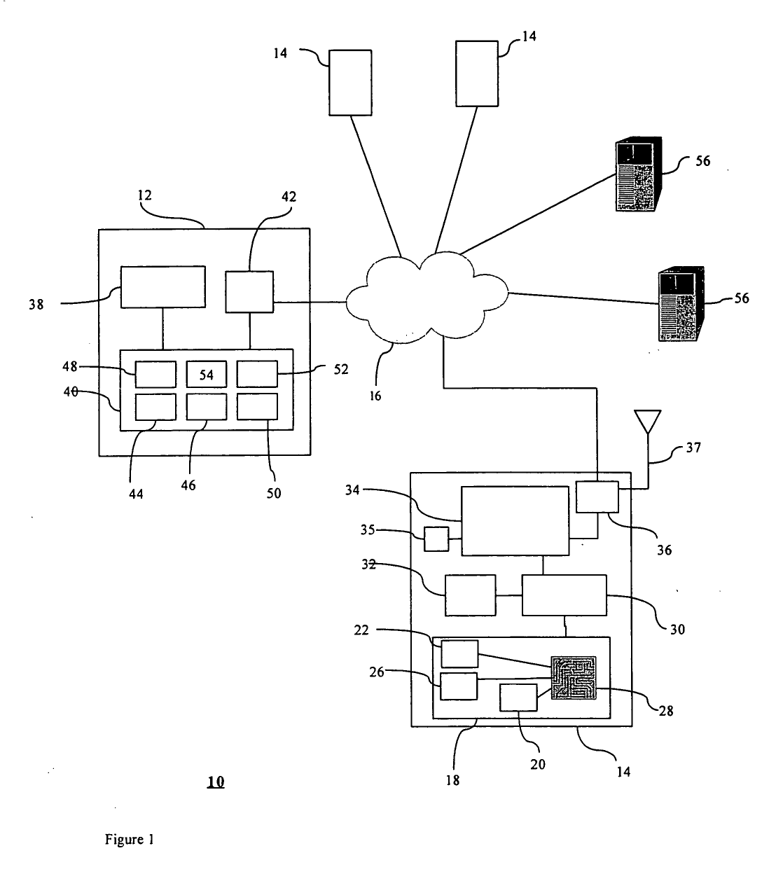

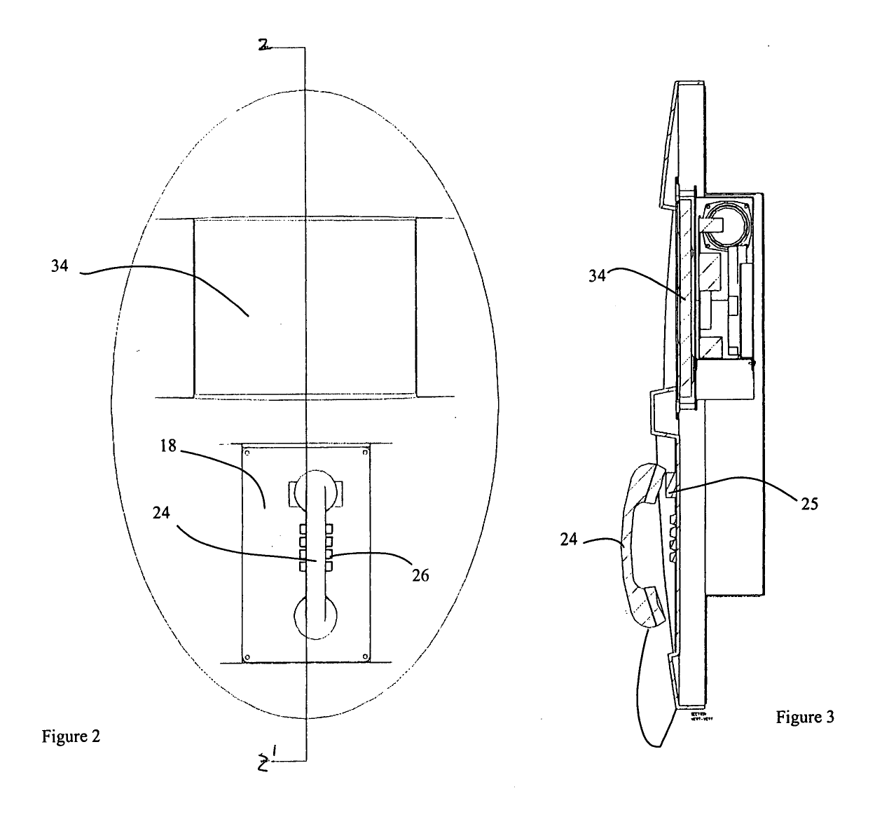

Referring to FIGS. 1, 2 and 3, there is shown a system 10 for providing telecommunication services while presenting multimedia promotional content. The system 10 includes a central server 12 and a plurality of terminals 14. Among its functions, the central server 12 distributes multimedia content to the plurality of terminals 14, and provides telecommunication services via a communication network 16. The terminal 14 has at least one access unit connected thereto for allowing the user to receive the telecommunication services. The access unit may be a telephone where telephony services are provided. The access unit may be a network connector where internet connection services are provided.

Internet connection services may be provided at terminal 14 either through a network connector for connecting a mobile computer thereto by a user or through a radio antenna for connecting to terminal 14 wirelessly. The network 16 may be broadband-based such as cable or xDSL, wireless, fixed wireless, public switched telephone network (PSTN), or the Internet. For increased security the network 16 may be a virtual private network (VPN) having the terminals 14 as VPN clients. Preferably, the telephony services are provided via the PSTN, however, the terminals 14 and the central server 12 may include suitable software and hardware for providing telephony services via the broadband connection to the network 16, such as voice over IP (VoIP).

In greater detail, the terminal 14 includes a telephone 18 with a transmitter 20 and a receiver 22 housed in a handset 24 received by a cradle 25. Alternatively, the transmitter 20 and the receiver 22 may be external to the handset 24, as in a conventional speaker phone. The cradle 25 is coupled to a conventional on hook means for placing the telephone 18 in an “on” state or “off” state, such that telephone calls are initiated by removing the handset 24 from the cradle 25. The telephone 18 also includes a data input device, such as a plurality of buttons 26, for entering a destination number of the called party. The buttons 26 may also be used for interacting with the system 10 when the system 10 includes a suitable interactive service such as an interactive voice recognition (IVR) system. The telephone 18 also includes a speech circuit means or a speech processor 28 for processing the speech input from the receiver 22 for transmission via the network 16, and processing speech signals from the called party.

The telephone 18 is coupled to a processor 30, a computer readable medium 32, a display 34, and a transceiver 36. The processor 30 directs the overall operation of the terminal 14. A computer program or set of instructions is typically coded or otherwise implemented on the processor 30 to enable the processor 30 to provide the functionality of the device 14. The computer readable medium 32 interfaces with the processor 30 and may store the program code and provide storage space for data useful in executing the program code and carrying out terminal 14 functions. The program readable medium 32 may be implemented as ROM, flash memory, non-volatile RAM, a magnetic disk, an optical disk, an IC memory card or a magnetic tape or any conventional memory format. The terminal 14 also includes at least one application program thereon, such as web browser, running on a operating system such as the MICROSOFT® Windows Operating System (OS), LINUX® OS or UNIX®.

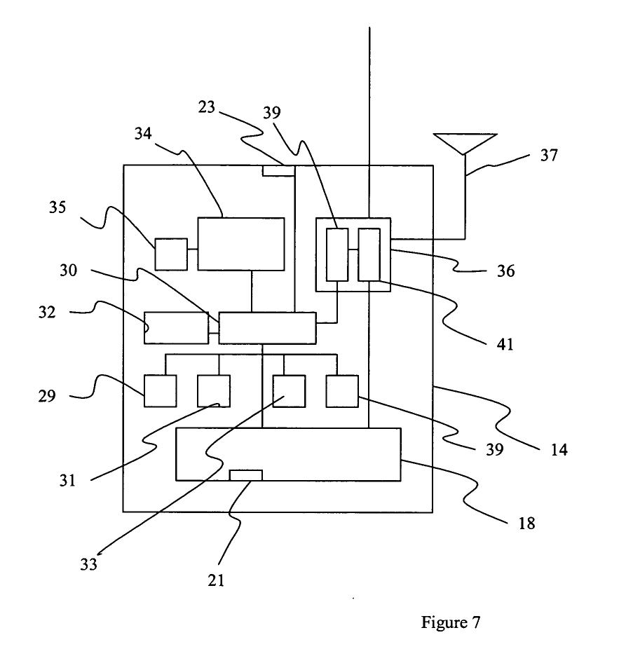

A network interface component 36 provides an interface between the terminal 14 and the network 16. In one embodiment, the network interface component is a transceiver 36. The transceiver 36 includes a transmitter and a receiver for exchanging voice and data with the network 16. In another embodiment, the network interface component 36 includes a DSL modem 39 and a filter 41. As shown in FIG. 7, an incoming line connects to filter 41, which separates the voice and data signals and routes the voice and data signals to different destinations. The voice signals are routed to the telephone 18. The data signals are routed to the DSL modem 39. The DSL modem connects processor 30 of the terminal 14 to the network 16 for exchanging data.

Conveniently, terminal 14 may provide an access point for a user to connect to the terminal 14 using the user's own mobile equipment, thus providing internet connection services to the user. As will be appreciated, internet services may be provided in a variety of manners, including dial-up connection and a direct Ethernet connection to an internet service provider. The access point may be in the form of an extra phone jack 21, built into the telephone 18, for a user to plug in a phone line connected to the mobile equipment so that the user may dial into a telephone number through which the central server 12 provides a dial-up internet connection service. The access point may also be in the form of a RJ-45 jack 23 mounted adjacent terminal 14 or built into telephone 18 to allow a network cable be connected thereto. Advantageously, the access point may also be in the form of an antenna 37 for providing a wireless connection to the network 16 using 802.11x transmission protocols based on specifications developed by the Institute of Electrical and Electronics Engineers (IEEE). A mobile telecommunication equipment, such as a laptop computer or a personal digital assistant (PDA), equipped with a Wi-Fi network interface card, may exchange data with the network 16 via the antenna 37 within its proximity.

The multimedia content is displayed on a display 34 that is suitably dimensioned and having a suitable resolution. An example of a suitable screen 34 includes a screen area of 14×11 inches, a resolution of 1024×768 pixels and a viewing angle of 170°×170°. An audio output is also associated with the display 34 to provide audio content to the advertisement, which is output to a terminal speaker 35, or terminal speakers 35. The audio circuit is coupled to the on hook circuit so that the audio output may be inhibited, or at least is reduced, when the handset is off hook. The terminal 14 is also provided with a power source which can be implemented with a rechargeable battery, AC means, or other suitable means. Advantageously, the multimedia content may be displayed on the user's own telecommunication equipment as well, if the user uses the equipment to exchange data with the network 16 via the access point, such as antenna 37.

The system 10 allows a user to interact with the system through a data input device. The user may use the buttons 26 of the telephone 18, for example, as a rudimentary input device. As shown in FIG. 7, the data input device in one embodiment include a keyboard 29, a mouse 31, a joystick 33 or other pointing device provided by the system, and a bar code scanner 39. It will be appreciated that while an input capability is provided by including one or all of above mentioned input devices, it is not necessary to include all of them. In another embodiment, there is provided an extra key pad having another set of buttons 26. The additional keypad is located at a height suitable for use by people in wheelchairs. Conveniently, the data input device may also be the microphone (not shown) housed in the receiver 22 of the telephone 18 or a dedicated microphone, coupled with a voice recognition application program executing on the processor 30. The data input device may also be in the form of a touch screen. The user may also use the input devices provided by the user's own mobile telecommunication equipment.

The functionalities of the central server 12 include processing program instructions for procurement of content, content management, distribution of content and fulfilment, traffic management and monitoring Quality of Service (QoS) characteristics of the communication network 16. The central server 12 includes a processor 38, a computer readable medium 40 having a content server 44, a database 46, a traffic manager 48, a reporting module 50, and a network interface 42. The central server 12 also includes at least one application program thereon, running on an operating system such as the MICROSOFT® Windows Operating System (OS), LINUX® OS, UNIX® OS or CISCO intemetworking OS (IOS).

In operation, the terminals 14 receive multimedia content from the central server 12 via the content server 44 which links to the database 46. The content server 44 can access content stored within itself or on other content servers 44. The content may include, but is not limited to advertisements in a plurality of formats such as full motion video (avi, any variant of mpeg, mov, or flash), static graphic images (jpeg, tiff, gif, or bmp) with or without an audio component, web pages, audio files with or without web pages or static graphic images, or uniform resource identifiers (URIs) to a plurality of content providers 56. The content providers 56 are coupled to the communication network 16, and each content provider 56 is registered with the central server 12 and provided with a unique identifier and access privileges to the central server 12.

The content server 44 includes a web server 52 in communication with the database 46 for transmitting web pages, such as hyper-text markup language (HTML) pages to the terminals 14. Also included in the content server 44 is a file transfer protocol (FTP) server 54, through which the content providers 56 can publish their content via an FTP session. The content server 44 may be browser based and supports the adding, editing, and deleting of content via a browser. Alternatively, content can be provided to the content server 44 via email or on fixed media such as a CD or a hard disk drive. Since raw multimedia content requires a large amount of bandwidth, the content is compressed using standard compression algorithms or proprietary compression tools to achieve lesser bandwidth and shorter transmission times, while maintaining acceptable quality. The traffic manager 48 in cooperation with the web server 52 selects the desired digital content from the database 46 for transmission to respective ones of the terminals 14. The selection for each terminal 14 is based on predetermined parameters such as location of the terminals, location owner, time of day, or content provider's preferences.

The operation of the system 10 will now be described with particular attention to the terminal 14. The terminals 14 are generally strategically placed in locations that experience consumer traffic such as malls, retail stores, airports or stadiums. The content, such as advertisements, is selected for a particular target audience. As an example, a terminal 14 located at a retail store, such as THE HOME DEPOT®, may include advertisements from BLACK & DECKER®, DEWALT®, MAKITA®, as well as other brands such as COKE® or MCDONALDS®. Also, the retail store has the option of including its own advertisements promoting its store products or other services.

In order to obtain customised advertisements, the terminals 14 communicate with the central server 12 via communication protocols such as Transmission Control Protocol/Internet Protocol (TCP/IP). Thus, each terminal 14 is identifiable to the central server 12 via a unique name, such as a Media Access Control (MAC). address of the terminal's network interface 36. In addition, each terminal 14 is associated with an IP address. Such identification allows for routing the information requests and content from the central server 12. At boot up, the terminal 14 reports to the central server 12 by sending a terminal status signal. This normally is implemented by sending the terminal's 14 MAC address and IP address to indicate that the terminal 14 is now coupled to the central server 12. The central server 12 then verifies the identity of the reporting terminal 14 in order to recognize it as a legitimate network 16 entity. After verifying the identity, the central server 12 then sends a configuration file to the terminal 14, where applicable.

The configuration file includes program code for desired operation of the terminal 14, such as instructions on how to operate the terminal 14, record interactions with consumer, communicate with the server 12, perform maintenance routines and details of the network topology such as the addresses of the network entities, and so forth. The configuration file also includes a content play list with URIs to the digital content, and predetermined times for which to play the content, instructions for refreshing the content for the terminal 14. Typically, the content play list is valid for a predetermined time period, such as a day. The URIs are pointers to the content location on the terminal 14 itself or the content server 44.

Generally, the content play list may be a text file in a comma delimited format that is uploaded to a local database on the terminal 14 via FTP or other protocols. Upon receiving the content play list file from the central server 12, the terminal 14 verifies whether the required content files are available locally on the terminal 14. If any content files are not present on the terminal 14, a request is sent to the central server 14 for the required files. This request may be transmitted as a standard data packet or as a proprietary packet of information. The terminal 14 then receives the content file from the central server 12 via an FTP session. As mentioned above, the content is compressed using standard compression algorithms or proprietary compression tools to achieve lesser bandwidth and shorter transmission times. Periodically, for example, every hour or every 15 minutes, the terminal 14 may contact the central server 12 and request that its locally stored content files be updated or re-synchronized with centrally stored content files. In a preferred embodiment, the terminal 14 requests update from the central server 12 every 15 minutes during the day. Should there be a need to change the content for the terminal 14 at any time during the day, the central server 12 may also transmit a request to the terminal 14 to begin a re-synchronization process. This process involves sending an updated content play list to the terminal 14 and repeating the steps of checking for the availability of the content files on the terminal 14, as described above.

Each terminal 14 also includes a log file listing any actions performed by the terminal 14, error messages, usage time of the telephone 18, the called telephone number, actions taken by the system 10 provider or information regarding the advertisements such as run length or time of day played.

Periodically, the central server 12 sends a status request to the terminal 14, such as a ping request, to determine the status of a terminal 14 and the status of the network connection to the terminal 14. Advantageously, the terminal 14 can be remotely controlled from the central server 12. Such remote control actions include restarting it or performing troubleshooting, maintenance or administrative functions through protocols such as Simple Network Management Protocol (SNMP).

At predetermined times, the central server 12 requests or retrieves the log files from each terminal 14. The log files are provided to the reporting module 50 which compiles reports pertaining to the viewership of the content, and other statistics having a variety of criteria as desired. These reports can be formatted as text tables or as line, bar, and pie graphs, or raw data for presentation on a web page, and are available to the content providers 56. Such reports may be used by the content providers 56 to better target the consumers, refine their advertisements or seek better advertising time slots. Alternatively, the system 10 provider can use these reports for time slot pricing, network maintenance and traffic management. It will be appreciated that although in the embodiment described, the reporting module 50 resides in the central server 12, terminal 14 may also have its reporting module for generating reports pertaining to the terminal 14.

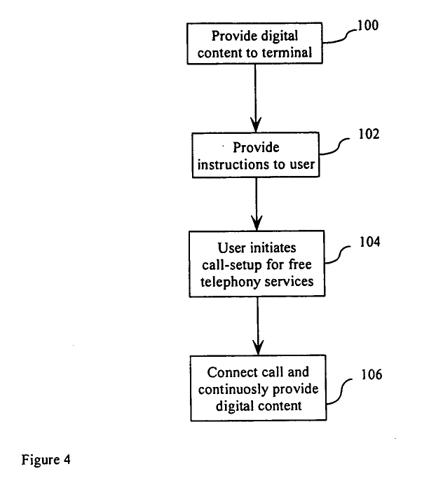

Referring now to FIG. 4, the flowchart shows the steps for a method for providing free telephone calls to a consumer, while simultaneously providing interactive multimedia content to the consumer and passers-by. In order to attract consumers, the terminal 14 is always on during predetermined time periods, generally during store hours, if located inside or adjacent to a retail store. During this period, the content such as full motion video with audio is played by the terminals 14. Promotional messages, usually advertisements, are shown in a loop, with each message being shown at predetermined times as determined by the content provider 56 or advertiser. For example, a content provider 56 may buy ad time slots between 12 pm and 2 pm in order to target a specific group such as those who frequent the location at lunchtime. In step 100, a consumer approaches a terminal 14 running advertisements and the terminal 14 provides auditory instructions via the terminal speakers 35 or visual instructions on the touch screen 34 to the consumer, or both, in the next step 102. The instructions may be directed to how to use the system 10 in order to make free phone calls.

In step 104, the consumer lifts the handset 24 in order to dial a desired number in order to initiate a telephone call. The switch or circuit means coupled to the cradle provides a signal to the processor 30 to disable the terminal speaker or reduce the speaker volume. This signal may also be used to interrupt the already running ad and initiate it, or start another ad instead. The call is routed through the PSTN to the desired called party via a conventional call-setup routine, or using VoIP technology, in step 106. The consumer proceeds with the call while the advertisements are running continuously, as described above. Given the wide viewing angle of the screen 34, the advertisements may also be viewed by other consumers or passers-by.

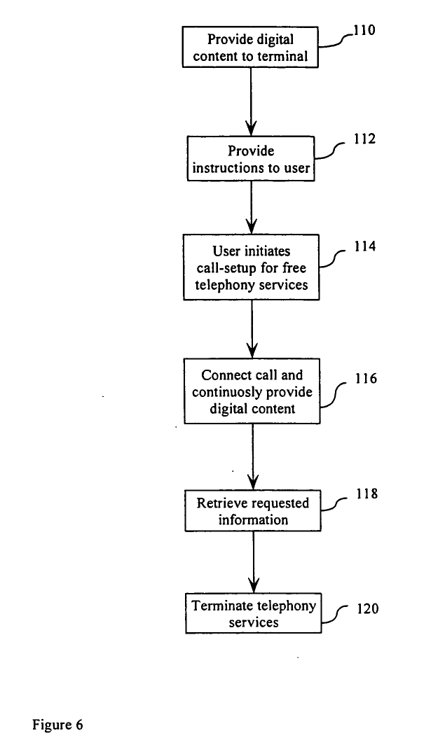

In one embodiment, the display 34 is implemented as a touch screen in order to provide input means via resistive touch technology to enable consumer interaction with the system 10. Looking at FIG. 6, in step 110, on approach by a consumer to the terminal 14, the terminal 14 may include proximity or motion sensors to detect the presence of the consumer. Upon such detection, the terminal 14 can interrupt an ad already in progress and start it from the beginning. In step 112, the terminal 14 provides auditory instructions via the terminal speakers 35 or visual instructions on the touch screen 34 to the consumer, or both. The instructions may be directed to how to use the system 10 in order to make free phone calls or internet connections, and how to simultaneously interact with the advertisements running on the display 34. Upon connection to terminal 14 via the antenna 37, the instructions may also be sent to be displayed by the user's own mobile telecommunication equipment.

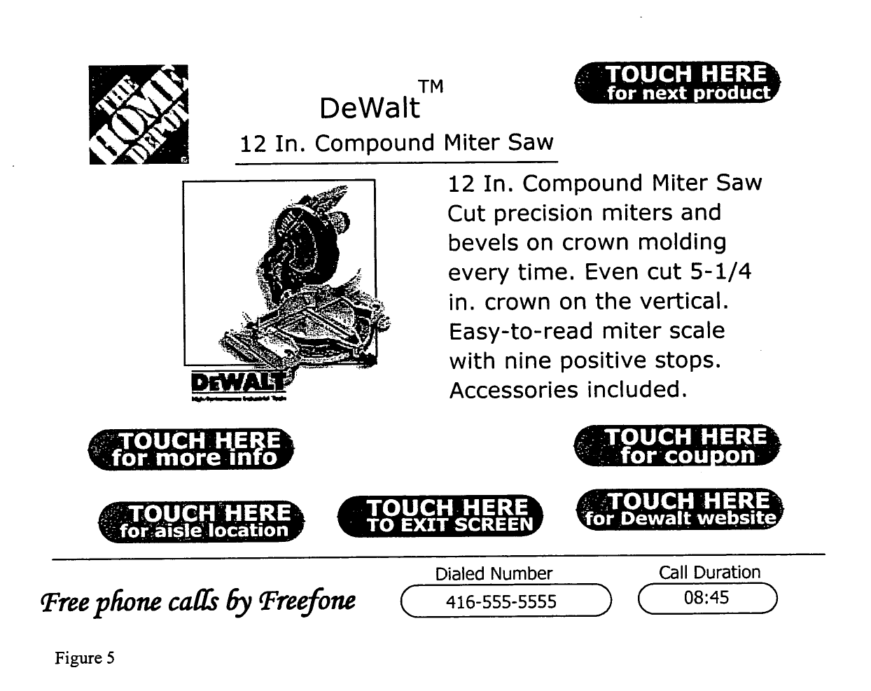

FIG. 5 shows an example of a touch screen 34 displaying an advertised product. In this example, a picture of the product is displayed, however it may also be a full-motion video advertisement of the product detailing its specifications, advantages or showing the product in use. The touch screen 34 also includes a short description of the product and selection areas for the consumer to invoke further product information, product location in the store, rebate information if available, and so forth. Once the telephone call has been initiated or a network connection to the user's mobile equipment is established, the consumer is prompted to make a selection by touching the display 34, in step 114, in order to request additional information for a product being advertised on the display 34. However, the consumer may choose to ignore the prompts on the display 34 for a selection and proceed with the call, or the consumer may make a selection.

Upon detection of an input by the consumer, an input signal is produced by the touch screen 34 and sent to the processor 30. The processor 30 interprets the input signal and in conjunction with an application program, such as a browser, provides the next page or retrieves additional information, in step 116. This step normally involves requesting another uniform resource locator to the additional information from the central server 12.

Any interaction with system 10 by the consumer is logged and stored in the log file on the computer readable medium 32. The log file provides information relating to the advertisements, such as identification of displayed advertisement while the consumer was interacting with the terminal 14, information requested by the consumer, interaction time spent by the consumer and usage time of the telecommunication service, whether the use of the telephone 18 or the internet connection services provided through the access point, such as antenna 37. Other information such as polling results, feedback may also be collected. For example, polling may be directed to usefulness of information received or ease of use of the system 10. In step 118, the consumer terminates the call, and may proceed with the interaction, at which point the audio may be enabled via the on hook circuit means.

In another embodiment of the invention, upon completion of the consumer request, a terminal 14 may issue a coupon for redemption at a point of sale within the retail store. The coupon may be an electronic coupon, or it may be a coupon dispensed by a coupon printer coupled to the terminal 14. The coupon is valid for the researched product, or any other products from the manufacturer, advertiser or retailer. To encourage the consumer to make the purchase, the coupon may be set to expire in a short time period, such as two hours or 10 minutes, depending on the nature of the merchandise, or the type of the store, among a number of factors. The terminal 14 may also provide the location of the researched item in the store, such as the aisle number.

In another embodiment, the terminal 14 includes a bar code reader 39, such that consumer can scan a machine-readable Universal Product Code (UPC) of a desired item, from a flyer for example, and receive additional information about the product. Alternatively, a consumer may scan a bar code on a product item and obtain information such as price, or product specifications. Additionally, the consumer may also be presented with a coupon for redemption at the point of sale terminal.

In another embodiment, the terminal 14 may have more than one display 34. Conveniently, the extra displays are all controlled by processor 30. Some or all of the extra displays may not provide input capability. The extra displays may each present different promotional contents, namely may each have different play lists. Any consumers waiting for the telephone 18 may view promotional contents shown on any one of these extra displays without having to interfere with the use of the telephone 18 by the other user. With additional displays, the terminal 14 permits several users to connect to the network 16 simultaneously via antenna 37, for example, each interacting with one of the displays provided while mininimizing interference with other's use of the terminal 14.

In another embodiment, the content files stored locally at terminal 14 are updated manually. A conventional removable storage device reader, such as a CD-ROM drive or a memory storage card reader or any other reading device for a suitable computer storage media; is provided. The reader (not shown) accepts a suitable readable storage medium. For example, the computer readable medium 32 may include a CD disc where a CD-ROM drive is provided or a memory card where a memory storage card reader. The reader is coupled with the processor 30 so that data stored on the medium are accessible to the processor 30. Periodically, the CD disc or memory card is replaced manually, instead of being updated automatically by the central server 12.

In another embodiment, the central server 12 may interact with a number of content servers 44. Each content server 44 has its own database 46 for storing promotional contents received from advertisers. Contents stored by the content server 44 may also include information contents, for example, weather or traffic information. Some of the content servers 44 may be entirely informational. Some may also be RSS feeds, providing a variety of different types of information. As will be appreciated, contents from these sources may be grouped into one data stream in many different manners and transferred to each terminal 14. Each terminal 14 may also retrieve contents from each of these sources separately and store them collectively on computer readable medium 32. For example, similar to that described in connection with the embodiment in which the system 10 has only one content server 44, traffic manager 48, in cooperation with the web server 52, selects the desired digital contents from each one of the content servers 44 for transmission to respective ones of the terminals 14. Each of the content servers 44 transfers the desired digital contents to the respective ones of the terminals 14 via an FTP session.

In another embodiment, promotional materials presented on display 34 may be overlaid with logos or special message text. The logo may be the system 10 provider's own logo, or the location owner's logo. The logo may be a static graphic file in a bitmap (bmp) format that may be positioned at a pre-determined location on the screen of display 34. The special message may direct a user's attention to a store special, or to the cost-free feature of the services provided by the system 10. The special message is overlaid with the promotional contents, so that it is always visible to the user no matter what video or graphic contents are shown on the screen of display 34. The message may be static text overlaid on a video clip, for example, or may be animated text to better attract a user's attention.

In another embodiment, the terminal 14 includes wireless LAN (WLAN) functionality, via a suitable radio transceiver 36 such as a 802.1 1x transceiver based on specifications developed by the Institute of Electrical and Electronics Engineers (IEEE). Therefore, the terminal 14 transmits product information or other information such as statistics to a mobile device such as a personal computer (PC), a mobile phone, or a personal digital assistant (PDA). The WLAN radio transceiver 36 may also be used to provide connectivity to the communication network 16.

In another embodiment, the terminal 14 provides reduced cost telecommunication services to at least one consumer while simultaneously providing multimedia promotional content to at least one consumer. Thus, the terminal 14 includes means for accepting payment for, for example, reduced cost telephone calls, such as long distance phone calls at reduced tariff rates.

In another embodiment, a conventional payphone is adapted to offer reduced cost or free telephone calls and is coupled to a processor 30, a computer readable medium 32, a suitable display 34, a transceiver 36 to provide similar terminal 14 functionalities, as described above.

In another embodiment, the terminal 14 is implemented as a desktop unit, being ideal for use in waiting rooms or office type locations.

Advantageously, consumers benefit from obtaining cost free services, and the location owners, such as the retail chain stores, benefit from a higher level of customer service, increased revenues. The terminals 14 are placed in locations at no cost to the location owners, who also receive a payment from the system 10 provider. By displaying advertisements pertinent to the location owners, such as advertisements for products located at that particular store, the consumer benefits from improved customer service. The increased product exposure and the proximity of the terminals 14 to the point of sale provide for improved product sales and revenues.

Advertisers benefit from showing their TV advertisements right in the actual retail location, or in facilities often visited by their target consumers. Therefore, by placing the terminals 14 in strategic locations and by showing specific advertisements, the advertiser is able to narrow the target segments and improve the effectiveness of its campaign. By using the same advertisements as seen on TV, the advertiser is able to keep its production costs low while increasing its targeted reach. National advertisers can distribute regionally focused or promotional material as they need, at no additional cost or effort. Other advantages of offering free telephony services include avoiding the need to make change for payphones and the telephony services are complete and without interruptions. Advertisers or product manufacturers can also benefit from purchasing the right to design the external appearance of the terminal 14, for example the design may emulate the appearance of the advertised product itself or may include indicia associated with the retail store, such as the store logo.

Although the invention has been described with reference to certain specific embodiments, various modifications thereof will be apparent to those skilled in the art without departing from the spirit and scope of the invention as outlined in the claims appended hereto.

1. A system for providing telecommunication services over a communication network to a user, while presenting simultaneously promotional content to the user, the system comprising:
a terminal connected to the communication network;
said terminal having an access unit for permitting the user to receive the telecommunication services and an output device for presenting the promotional content;
a content server connected to the communication network for providing the promotional content; and
a central server connected to the communication network for providing the telecommunication services to the user and for directing said content server to provide the promotional content to said terminal.

2. The system of claim 1, wherein said access unit is a telephone set.

3. The system of claim 2, further comprising a circuit element to reduce output of audio component of the promotional content when said telephone set is in use.

4. The system of claim 1, wherein said access unit is a network connector for permitting the user to connect a mobile telecommunication equipment to said terminal.

5. The system of claim 4, wherein said network connector is a radio antenna for permitting the user to connect a mobile telecommunication equipment to said terminal wirelessly.

6. The system of claim 1, further comprising a payment acceptance device, wherein said access unit permits the user to receive the telecommunication services upon receipt of a payment by the user.

7. The system of claim 1, wherein said output device includes a graphic display and a terminal speaker for presenting the promotional content in a multimedia format.

8. The system of claim 1, wherein said output device includes a plurality of graphic displays and terminal speakers.

9. The system of claim 1, wherein said terminal further comprises a data input device for the user to interact with the system.

10. The system of claim 9, wherein said data input device is one of telephone key pad, bar code scanner, computer keyboard, joystick, and computer mouse.

11. The system of claim 9, wherein said data input device is a microphone for receiving auditory signal from the user and said terminal further includes a voice recognition processor for converting said auditory signal to the corresponding instructions and data.

12. The system of claim 9, wherein said output device includes a graphic screen and said data input device is a touch screen built into said graphic screen.

13. The system of claim 1, wherein said terminal further comprises a monitor for detecting an initiation request from the user for establishing a telecommunication session.

14. The system of claim 13, wherein said terminal is operable to present a different portion of the promotional content upon detecting the initiation request.

15. The system of claim 13, further comprising recording means for recording usage data of the telecommunication system.

16. The system of claim 15, wherein said usage data includes time duration of said telecommunication session and a reference to the promotional content presented during said communication session.

17. The system of claim 16, wherein said central server receives said usage data from said terminal at pre-determined time intervals for compiling statistical information of usage of said terminal from said usage data.

18. The system of claim 1, wherein said terminal further comprises a processor, said processor being programmed to control network communication between said access unit and said central server and being programmed to receive the promotional content and present the promotional content on said output device.

19. The system of claim 18, wherein said terminal further comprises a computer readable medium for storing a copy of the promotional content, said computer readable medium being accessible to said processor.

20. The system of claim 19, wherein said processor is programmed to receive from said content server at pre-determined time intervals an updated copy of the promotional content for storing on said computer readable medium.

21. The system of claim 19, wherein said terminal further comprises a coupon generator controllable by said processor for producing a customized coupon.

22. The system of claim 21, wherein said customized coupon is for a merchandise available at a store adjacent said terminal.

23. The system of claim 22, wherein said customized coupon expires at a pre-determined time to encourage purchase of the merchandise by the user from the store.

24. A terminal for use in a telecommunication system for providing telecommunication services over a communication network to a user, while presenting simultaneously promotional content to the user, the terminal comprising:
an access unit for permitting the user to receive the telecommunication services;
an output device for presenting the promotional content; and
a processor, said processor being programmable to control network communication between said access unit and the communication network, to receive the promotional content and to present the promotional content on said output device.

25. The terminal of claim 24, wherein said access unit is a telephone set.

26. The terminal of claim 25, further comprising a circuit element to reduce output of audio component of the promotional content while the telephone set is in use.

27. The terminal of claim 24, wherein said access unit is a network connector for permitting the user to connect a mobile telecommunication equipment to said terminal.

28. The terminal of claim 24, wherein said network connector is a radio antenna for permitting the user to connect a mobile telecommunication equipment to said terminal wirelessly.

29. The terminal of claim 24, further comprising a payment acceptance device, wherein said access unit permits the user to receive the telecommunication services upon receipt of a payment by the user.

30. The terminal of claim 24, wherein said output device includes a graphic display and a terminal speaker for presenting the promotional content in a multimedia format.

31. The terminal of claim 24, wherein said terminal further comprises a data input device for the user to interact with the system.

32. The terminal of claim 31, wherein said data input device is one of telephone keypad, bar code scanner, computer keyboard, joystick, and computer mouse.

33. The terminal of claim 24, wherein said data input device is a microphone for receiving auditory signal from the user and said terminal further comprises a voice recognition processor for converting said auditory signal to the corresponding instructions and data.

34. The terminal of claim 24, wherein said output device includes a graphic display and said data input device is a touch screen built into said graphic display.

35. The terminal of claim 24, wherein said terminal further comprises a computer readable medium for storing a copy of the promotional content, said computer readable medium being accessible to said processor.

36. The terminal of claim 35, wherein said computer readable medium is removable from said terminal.

37. The terminal of claim 24, wherein said processor is programmed to receive from a content server of the telecommunication system at pre-determined time intervals an updated copy of the promotional content for storing on said computer readable medium.

38. The terminal of claim 24, wherein said processor is programmed to receive the promotional content from a plurality of information sources at pre-determined time intervals for storing the received promotional content on said computer readable medium, the promotional content being distributed among the information sources.

39. A method of providing telecommunication services to a user, the method comprising the steps of:
providing a terminal from which the user receives the telecommunication services, said terminal having an output device for presenting promotional content;
receiving a request from the user for receiving the telecommunication services;
providing the requested telecommunication services; and
presenting the promotional content on said output devices.

40. The method of claim 39, further comprising the step of presenting a portion of the promotional content in a pre-determined sequence prior to the step of receiving the request.

41. The method of claim 39, further comprising the step of providing a telephone set connected to the terminal for providing telephony services.

42. The method of claim 41, further comprising the step of reducing output of audio component of the promotional content while the telephone set is in use.

43. The method of claim 39, further comprising the step of providing a network connector for permitting the user to connect a mobile telecommunication equipment to said terminal.

44. The method of claim 39, further comprising the step of providing a payment acceptance device, wherein said terminal provides the requested telecommunication services upon receipt of a payment by the user.

45. The method of claim 39, further comprising the steps of:
storing the promotional content on a computer readable medium, said computer readable medium being accessible to a processor housed by said terminal; and
retrieving the promotional content from said computer readable medium for presenting to the user upon detection of said request.

46. The method of claim 45, further comprising the steps of:
receiving from said content server at pre-determined time intervals an updated copy of the promotional content; and
storing said updated copy on said computer readable medium.

47. The method of claim 45, further comprising the step of:
replacing said computer readable medium at pre-determined time intervals to replace the promotional content stored thereon.

48. The method of claim 45, further comprising the steps of:
storing a pre-determined presentation sequence on said computer readable medium; and
causing said processor to present the promotional content in a loop according to said pre-determined presentation sequence prior to receiving the request.

49. The method of claim 39, further comprising the steps of:
providing a removable computer readable medium, said removable computer readable medium having a copy of the promotional content stored thereon, said removable computer readable medium being accessible to a processor housed by said terminal; and
retrieving said copy of the promotional content from said removable computer readable medium for presenting to the user upon detection of said request.

50. The method of claim 39, said method further comprising the step of producing a customized coupon for merchandise available from a store adjacent the terminal.

51. The method of claim 50, said method further comprising the step of associating a pre-determined expiration time with said customized coupon to encourage purchase of the merchandise by the user from the store.

52. The method of claim 39, said method further comprising the step of producing a customized coupon for a product from a manufacturer associated with the promotional content.

53. The method of claim 39, further comprising the steps of:
providing a data input device associated with said terminal;
receiving a request for the promotional content entered by the user on said data input device; and
providing the requested promotional content.

54. The method of claim 39, wherein the step of presenting the promotional content to the user includes displaying the promotional content on a touch screen.

55. The method of claim 54, further comprising the steps of:
receiving a request for the promotional content entered by the user on said touch screen; and
providing the requested promotional content.

56. The method of claim 39, further comprising the steps of:
providing a content server, said content server having a content database;
receiving an updated copy of the promotional content from an advertiser; and
storing said updated copy in said content database.

57. The method of claim 56, wherein said terminal further includes a processor and a computer readable medium accessible to said processor, and said method further comprising the steps of:
programming said processor to receive over a telecommunication network the promotional content from said content server at pre-determined time interval;
storing the received promotional content on said computer readable medium; and
retrieving the received promotional content from said computer readable medium for presenting to the user upon detection of said request.

58. The method of claim 39, wherein said terminal further includes a processor and a computer readable medium accessible to said processor, and said method further comprising the steps of:
designating a plurality of information sources for receiving the promotional content, the promotional content being distributed among the information sources and the information sources being accessible to the processor over a telecommunication network;
receiving a copy of the promotional content from the plurality of information sources;
storing the received copy of the promotional content on said computer readable medium; and
retrieving the received copy of the promotional content from said computer readable medium for presenting to the user.

59. A system for providing telecommunication services over a communication network to a user, while presenting simultaneously promotional content to the user, the system comprising:
a terminal connected to the communication network;
said terminal having an access unit for permitting the user to receive the telecommunication services, a display screen, a terminal speaker, a computer readable medium and a processor;
said processor being programmable to control network connection between said access unit and the communication network;
said display screen, said terminal speaker and said computer readable medium being accessible to said processor;
a content server connected to the communication network, said content server having a content database for storing the promotional content; and
a central server connected to the communication network for providing the telecommunication services to the user and for directing said content server to provide the promotional content to said terminal.

60. The system of claim 59, wherein said access unit is a telephone set.

61. The system of claim 60, further comprising a circuit element to reduce output of audio component of the promotional content when said telephone set is in use.

62. The system of claim 59, wherein said access unit is a network connector for permitting the user to connect a mobile telecommunication equipment to said terminal.

63. The system of claim 62, wherein said network connector is a radio antenna for permitting the user to connect a mobile telecommunication equipment to said terminal wirelessly.

64. The system of claim 59, further comprising a payment acceptance device, wherein said access unit permits the user to received the telecommunication services upon receipt of a payment by the user.

65. The system of claim 59, wherein said terminal further comprises a monitor for detecting an initiation request from the user for establishing a telecommunication session.

66. The system of claim 65, wherein said terminal is operable to present a different portion of the promotional content upon detecting the initiation request.

67. The system of claim 65, further comprising recording means for recording usage data of the telecommunication system.

68. The system of claim 67, wherein said usage data including time duration of said telecommunication session and a reference to the promotional content presented during said communication session.

69. The system of claim 68, wherein said central server receives said usage data from said terminal at pre-determined time intervals for compiling statistical information of usage of said terminal from said usage data.
